(19) United States
(12) Patent Application Publication
(10) Pub. No.: US 2020/0337302 A1
(43) Pub. Date: Oct. 29, 2020

(54) METHOD FOR MANUFACTURING ANTIMICROBIAL ADHESIVE FILM

(71) Applicant: KOREA INSTITUTE OF INDUSTRIAL TECHNOLOGY, Cheonan-si Chungcheongnam-do (KR)

(72) Inventors: Tae Won KIM, Gwangju (KR); Jae Cheol PARK, Jeollanam-do (KR)

(21) Appl. No.: 16/764,880

(22) PCT Filed: Nov. 16, 2018
(86) PCT No.: PCT/KR2018/014100

§ 371 Date: May 18, 2020

(30) Foreign Application Priority Data
Nov. 20, 2017 (KR) 10-2017-0154761

(51) Int. Cl. A01N 25/10; A01N 59/20; A01N 59/16

(52) U.S. Cl. CPC A01N 25/10; A01N 59/16; A01N 59/20

(57) ABSTRACT

Disclosed is a method of manufacturing an antimicrobial adhesive film including (a) providing an adhesive film including a substrate film and an adhesive layer formed on one surface of the substrate film, (b) forming a laminated film including an antimicrobial material layer/substrate film/adhesive layer by applying an antimicrobial solution including an antimicrobial material and a solvent on the remaining surface of the substrate film of the adhesive film and performing drying, and (c) manufacturing an antimicrobial adhesive film including a substrate film/adhesive layer/antimicrobial material layer by rolling the laminated film into a cylinder shape so that the antimicrobial material layer and the adhesive layer are brought into contact with each other to thereby transfer the antimicrobial material layer onto the adhesive layer.

### TECHNICAL FIELD

The present invention relates to a method of manufacturing an antimicrobial adhesive film, and more particularly to a method of manufacturing an antimicrobial adhesive film, which is capable of completely sealing medical waste to prevent odors from escaping therefrom and minimizing noise when the film is peeled and exhibits excellent antimicrobial activity.

### BACKGROUND ART

With the recent increase in the outbreak not only of new contagious diseases such as novel swine-origin influenza A, Middle East respiratory syndrome (MERS), Zika virus and super bacteria but also of infectious bacteria, the number of patients infected therewith is also increasing. Accordingly, the risk of secondary infections in hospitals is also increasing for the general public and medical personnel, including laboratory researchers, and thorough research into therapeutic agents and vaccines for treating contagious diseases is ongoing. Prevention and personal hygiene are recognized as important in order to prevent secondary infections in hospitals or laboratories, but most importantly, medical waste must be safely disposed of in order to eliminate the possibility of secondary infections. For this reason, it is time to improve the environment of hospitals and laboratories using safe medical waste disposal devices in order to safely dispose of waste and prevent biological hazards. If the above medical waste is not safely and properly disposed of, secondary infections in hospitals, or infections in the course of research conducted by the corresponding researchers, occur, which seriously affects the public health and the results of research, and also cause social problems.

“Medical waste” refers to various kinds of waste discharged from hospitals, public health centers and medical research institutes, and examples thereof include cotton wool, gauze, bandages, diapers, human body extracts, inspection tools such as syringes, needles, thermometers and test tubes, analytical devices, X-ray film developer and organic solvents, which are also considered medical-related waste or hospital waste.

Such medical waste is dangerous due to contamination with various harmful substances such as pathogens, heavy metals, poisons or blood of specific patients, and incurs a great risk of injury due to needles, broken glass, etc. When medical waste is generated in hospitals, immediate disposal thereof is difficult, and thus it is disposed in a manner in which medical waste is placed in separate medical-waste collection containers and is incinerated by waste disposal companies. However, these disposal methods do not completely prevent the generation of gas from contaminants, and spread by secondary infections in hospitals due thereto becomes problematic.

Therefore, methods that are able to exhibit a complete sealing function and to block contaminants compared to conventional pathogenic waste disposal methods are required.

### DISCLOSURE

### Technical Problem

Accordingly, the present invention has been made keeping in mind the problems encountered in the related art, and an objective of the present invention is to provide a method of manufacturing an antimicrobial adhesive film, in which the film is rolled into a cylinder shape to thereby transfer an antimicrobial material onto an adhesive layer, so there is no limitation on use of solvents due to no reactivity between an adhesive and an antimicrobial solution, and the manufacturing process is easy.

Another objective of the present invention is to provide a method of manufacturing an antimicrobial adhesive film, which is capable of completely sealing medical waste to prevent odors from escaping therefrom and minimizing noise when the film is peeled and exhibits excellent antimicrobial activity.

### Technical Solution

An aspect of the present invention provides a method of manufacturing an antimicrobial adhesive film 20 including (a) providing an adhesive film 100 including a substrate film 110 and an adhesive layer 120 formed on one surface of the substrate film 110, (b) forming a laminated film 10 including an antimicrobial material layer 200/substrate film 110/adhesive layer 120 by applying an antimicrobial solution including an antimicrobial material and a solvent on the remaining surface of the substrate film 110 of the adhesive film 100 and performing drying, and (c) manufacturing an antimicrobial adhesive film 20 including a substrate film 110/adhesive layer 120/antimicrobial material layer 200 by rolling the laminated film into a cylinder shape so that the antimicrobial material layer 200 and the adhesive layer 120 are brought into contact with each other to thereby transfer the antimicrobial material layer 200 onto the adhesive layer 120.

The rolling into a cylinder shape in step (c) may be performed in a manner in which the antimicrobial material layer 200 is located at the outermost position of the cylinder shape and rolled or in a manner in which the adhesive layer 120 is located at the outermost position of the cylinder shape and rolled.

The rolling into a cylinder shape in step (c) may be performed in a manner in which the antimicrobial material layer 200 is located at the outermost position of the cylinder shape and rolled.

The method of the present invention may further include (b′) controlling the concentration of the antimicrobial material in the antimicrobial solution so that the antimicrobial material is uniformly distributed on the remaining surface of the substrate film 110 of the adhesive film 100 and is formed on a portion of the remaining surface thereof, before step (b).

The applying in step (b) may be performed through any one process selected from the group consisting of spray coating, blade coating and gravure coating.

The antimicrobial material of step (b) may include metal nanoparticles including at least one selected from the group consisting of Ag, Cu, Pt, Au, Zn and Pd.

The antimicrobial material of step (b) may include oxide nanoparticles including at least one selected from the group consisting of TiO₂, ZnO, CaO and SiO₂.

The antimicrobial material of step (b) may be an antimicrobial organic material including phytoncide.

The solvent of step (b) may include at least one selected from the group consisting of sodium citrate, ionic liquid, ethanol, methanol, isopropyl alcohol and water.

The substrate film of step (a) may include at least one selected from the group consisting of polyethylene (PE), polypropylene (PP), polyimide (PI), polyethylene terephthalate (PET), polycarbonate and polyethylene naphthalate.

The substrate film of step (a) may have a thickness of 10 to 100 μm.

The adhesive layer 120 of step (a) may include at least one selected from the group consisting of rubber, acrylic polymer, adipate-based polymer, silicone-based polymer and urethane-based polymer.

The adhesive layer 120 of step (a) may have a thickness of 0.1 to 10 μm.

Here, step (a) may include (a-1) providing a substrate film 110 and (a-2) forming an adhesive layer 120 including an adhesive on one surface of the substrate film 110.

Another aspect of the present invention provides a method of manufacturing an antimicrobial adhesive film 20′ including (1) manufacturing an antimicrobial material layer 200′/substrate film 110′ by applying an antimicrobial solution including an antimicrobial material and a solvent on one surface of a substrate film 110′ and performing drying, (2) manufacturing a laminated film 10′ including an antimicrobial material layer 200′/substrate film 110′/adhesive layer 120′ by forming an adhesive layer 120′ on the remaining surface of the substrate film 110′ of the antimicrobial material layer 200′/substrate film 110′, and (3) manufacturing an antimicrobial adhesive film 20′ including a substrate film 110′/adhesive layer 120′/antimicrobial material layer 200′ by rolling the laminated film 10′ into a cylinder shape so that the antimicrobial material layer 200′ and the adhesive layer 120′ are brought into contact with each other to thereby transfer the antimicrobial material layer 200′ onto the adhesive layer 120′.

The rolling into a cylinder shape in step (3) may be performed in a manner in which the antimicrobial material layer 200′ is located at the outermost position of the cylinder shape and rolled or in a manner in which the adhesive layer 120′ is located at the outermost position of the cylinder shape and rolled.

The rolling into a cylinder shape in step (3) may be performed in a manner in which the antimicrobial material layer 200′ is located at the outermost position of the cylinder shape and rolled.

Still another aspect of the present invention provides a method of sealing waste including providing an antimicrobial adhesive film 20, 20′ produced by the above method of manufacturing the antimicrobial adhesive film 20, 20′, locating waste on a portion of the adhesive layer 120, 120′ of the antimicrobial adhesive film 20, 20′, and sealing the waste by folding the adhesive layer 120, 120′ of the antimicrobial adhesive film 20, 20′ so as to come into contact with itself and adhering the remaining portion of the adhesive layer 120, 120′.

### Advantageous Effects

According to the present invention, the manufactured antimicrobial adhesive film has no reactivity between the adhesive and the antimicrobial solution, so there is no limitation on use of solvents and the manufacturing process is easy.

In addition, medical waste is completely sealed to prevent odors from escaping therefrom and noise is minimized when the film is peeled, and moreover, excellent antimicrobial activity can result.

### BRIEF DESCRIPTION OF DRAWINGS

FIG. 1 schematically shows the structure of an antimicrobial adhesive film;

FIG. 2 schematically shows the structure when a contaminant is sealed with the antimicrobial adhesive film;

FIG. 3 is a flowchart showing a process of manufacturing an antimicrobial adhesive film according to an embodiment of the present invention;

FIG. 4 is a flowchart showing a process of manufacturing an antimicrobial adhesive film according to another embodiment of the present invention;

FIG. 5a is a graph showing changes in odor intensity depending on the type of film after addition of 100 μl of a NH₄OH aqueous solution;

FIG. 5b is a graph showing changes in odor intensity depending on the type of film after addition of 200 μl of a NH₄OH aqueous solution;

FIG. 6 shows SEM surface images depending on the amount of Ag in the antimicrobial adhesive films of Examples 3-1 to 3-4 and Control Example 3-1 (top: ×1k, bottom: ×10k);

FIG. 7 is a graph showing the results of analysis of EDS composition for the SEM images of FIG. 6;

FIG. 8 shows AFM surface analysis images of the antimicrobial adhesive films of Examples 3-1 to 3-4 and Control Example 3-1; and

FIG. 9 shows SEM surface images of Examples 3-9 to 3-12.

### BEST MODE

Hereinafter, exemplary embodiments of the present invention are described in detail with reference to the appended drawings so as to be easily performed by a person having ordinary skill in the art.

However, the following description does not limit the present invention to specific embodiments, and in the description of the present invention, detailed descriptions of related known techniques incorporated herein will be omitted when the same may make the gist of the present invention unclear.

The terms herein are used to explain specific embodiments, and are not intended to limit the present invention. Unless otherwise stated, a singular expression includes a plural expression. In the present application, the terms “comprise”, “include” or “have” are used to designate the presence of features, numbers, steps, operations, elements, parts, or combinations thereof described in the specification, and should be understood as not excluding the additional presence or possible presence of one or more different features, numbers, steps, operations, elements, parts, or combinations thereof.

As used herein, the terms “first”, “second”, etc. may be used to describe various elements, but these elements are not to be construed as being limited by these terms. These terms are only used to distinguish one element from another. For example, a first element may be termed a second element, and similarly, a second element may be termed a first element, without departing from the scope of the present invention.

Further, it will be understood that when an element is referred to as being “formed” or “laminated” on another element, it can be formed or laminated so as to be directly attached to all surfaces or to one surface of the other element, or intervening elements may be present therebetween.

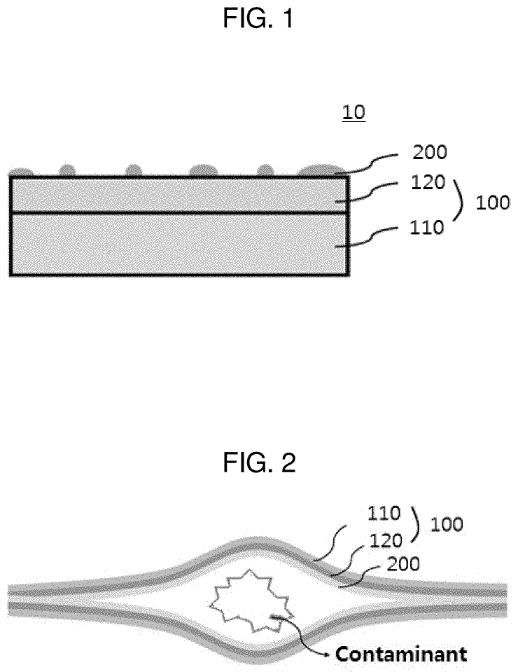

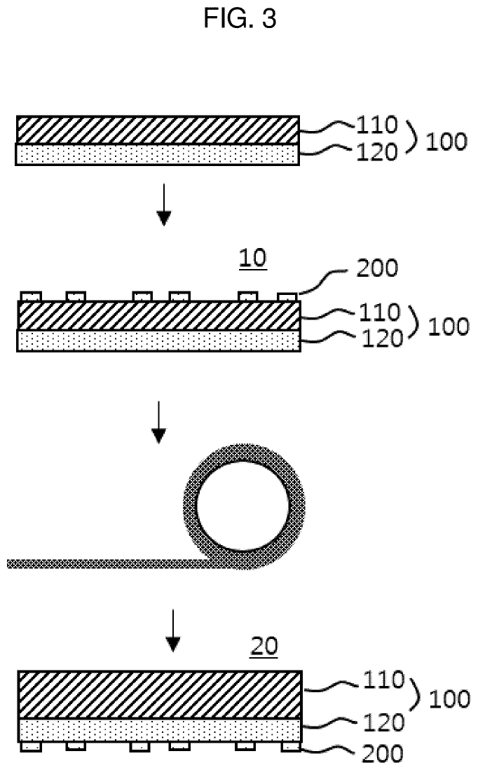

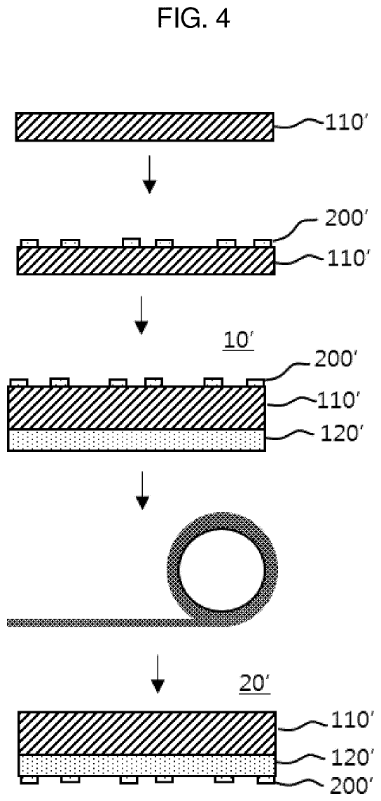

FIG. 1 schematically shows the structure of an antimicrobial adhesive film, and FIG. 2 schematically shows the structure when a contaminant is sealed with the antimicrobial adhesive film. Also, FIG. 3 is a flowchart showing a process of manufacturing an antimicrobial adhesive film according to an embodiment of the present invention.

With reference to FIGS. 1 to 3, the method of manufacturing the antimicrobial adhesive film according to the present invention is described below.

First, an adhesive film 100 including a substrate film 110 and an adhesive layer 120 formed on one surface of the substrate film 110 is provided (step a).

The substrate film 110 of step (a) may include at least one selected from the group consisting of polyethylene (PE), polypropylene (PP), polyimide (PI), polyethylene terephthalate (PET), polycarbonate and polyethylene naphthalate.

The thickness of the substrate film 110 of step (a) may be 10 to 100 μm.

The adhesive layer 120 of step (a) may include at least one selected from the group consisting of rubber, acrylic polymer, adipate-based polymer, silicone-based polymer and urethane-based polymer.

The thickness of the adhesive layer 120 of step (a) may be 0.1 to 10 μm.

Step (a) may include (a-1) providing a substrate film 110 and (a-2) forming an adhesive layer 120 including an adhesive on one surface of the substrate film 110.

Next, an antimicrobial solution including an antimicrobial material and a solvent is applied on the remaining surface of the substrate film 110 of the adhesive film 100 and is then dried, thus forming a laminated film 10 including an antimicrobial material layer 200/substrate film 110/adhesive layer 120 (step b).

Before step (b), (b′) controlling the concentration of the antimicrobial material in the antimicrobial solution so that the antimicrobial material is uniformly distributed on the remaining surface of the substrate film 110 of the adhesive film 100 and is formed on a portion of the remaining surface thereof, may be further performed.

The application process in step (b) may be performed through any one process selected from the group consisting of spray coating, blade coating and gravure coating.

The antimicrobial material of step (b) may include metal nanoparticles including at least one selected from the group consisting of Ag, Cu, Pt, Au, Zn and Pd, and is preferably Ag.

The antimicrobial material of step (b) may include oxide nanoparticles including at least one selected from the group consisting of TiO₂, ZnO, CaO and SiO₂.

The antimicrobial material of step (b) may be an antimicrobial organic material including phytoncide.

The solvent of step (b) may include at least one selected from the group consisting of sodium citrate, ionic liquid, ethanol, methanol, isopropyl alcohol and water.

Finally, the laminated film 10 is rolled into a cylinder shape so that the antimicrobial material layer 200 and the adhesive layer 120 are brought into contact with each other to thereby transfer the antimicrobial material layer 200 onto the adhesive layer 120, thus manufacturing an antimicrobial adhesive film 20 including a substrate film 110/adhesive layer 120/antimicrobial material layer 200 (step c).

The process of rolling into a cylinder shape in step (c) may be carried out in a manner in which the antimicrobial material layer 200 is located at the outermost position of the cylinder shape and rolled, or in a manner in which the adhesive layer 120 is located at the outermost position of the cylinder shape and rolled. Preferably, the process of rolling into a cylinder shape is carried out in a manner in which the antimicrobial material layer 200 is located at the outermost position of the cylinder shape and rolled.

Conventionally, the antimicrobial material is directly sprayed onto the adhesive layer, which causes a problem of leakage of odor owing to reduced adhesion due to reactivity between the adhesive and the dispersion solvent. Moreover, since antimicrobial activity may be decreased due to the adhesive applied on the surface of the antimicrobial particles, designing an optimized process is very complicated. However, when the antimicrobial material is applied on the remaining surface of the substrate film 110 opposite the surface on which the adhesive layer is formed and then transferred, there is no reactivity between the adhesive and the solvent, so the range of usable solvents is wide, and the process for manufacturing the antimicrobial adhesive film is easily designed.

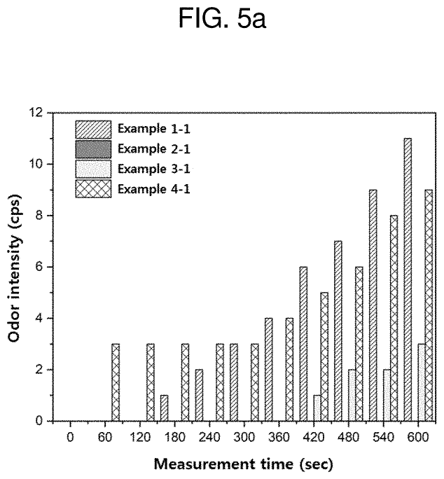

FIG. 4 is a flowchart showing a process of manufacturing an antimicrobial adhesive film according to another embodiment of the present invention.

With reference to FIG. 4, the method of manufacturing the antimicrobial adhesive film according to the present invention is described below.

First, an antimicrobial solution including an antimicrobial material and a solvent is applied on one surface of a substrate film 110′ and is then dried, thus manufacturing an antimicrobial material layer 200′/substrate film 110′ (step 1).

Next, an adhesive layer 120′ is formed on the remaining surface of the substrate film 110′ of the antimicrobial material layer 200′/substrate film 110′, thus manufacturing a laminated film 10′ including an antimicrobial material layer 200′/substrate film 110′/adhesive layer 120′ (step 2).

Finally, the laminated film 10′ is rolled into a cylinder shape so that the antimicrobial material layer 200′ and the adhesive layer 120′ are brought into contact with each other to thereby transfer the antimicrobial material layer 200′ onto the adhesive layer 120′, thus manufacturing an antimicrobial adhesive film 20′ including a substrate film 110′/adhesive layer 120′/antimicrobial material layer 200′ (step 3).

The process of rolling into a cylinder shape in step (3) may be carried out in a manner in which the antimicrobial material layer 200′ is located at the outermost position of the cylinder shape and rolled, or in a manner in which the adhesive layer 120′ is located at the outermost position of the cylinder shape and rolled. Preferably, the process of rolling into a cylinder shape is carried out in a manner in which the antimicrobial material layer 200′ is located at the outermost position of the cylinder shape and rolled.

In addition, the present invention pertains to a method of sealing waste including providing an antimicrobial adhesive film 20, 20′ produced by the above method of manufacturing the antimicrobial adhesive film 20, 20′, locating waste on a portion of the adhesive layer 120, 120′ of the antimicrobial adhesive film 20, 20′, and sealing the waste by folding the adhesive layer 120, 120′ of the antimicrobial adhesive film 20, 20′ so as to come into contact with itself and adhering the remaining portion of the adhesive layer 120, 120′.

### MODE FOR INVENTION

### Examples

A better understanding of the present invention will be given through the following examples. However, these examples are merely set forth to illustrate the present invention, and are not to be construed as limiting the scope of the present invention.

### Preparation Example 1: Preparation of Antimicrobial Solution Including Silver Nanoparticles

### Preparation Example 1-1

In order to manufacture an antimicrobial adhesive film, an Ag powder having a particle size of 40 nm as an antimicrobial material and methanol as a dispersion solvent were used. 0.1 g of an Ag powder was added to 100 ml of methanol and sonicated so that the Ag powder was dispersed in methanol, thus preparing an antimicrobial solution.

### Preparation Examples 1-2 to 1-8

Antimicrobial solutions were prepared in the same manner as in Preparation Example 1-1, with the exception that the amount of the antimicrobial material (Ag) that was used was changed as shown in Table 1 below.

### Preparation Examples 2-1 to 2-4

Antimicrobial solutions were prepared in the same manner as in Preparation Example 1-1, with the exception that ethanol was used as the dispersion solvent in lieu of methanol and the amount of the antimicrobial material (Ag) that was used was changed, as shown in Table 1 below.

### Comparative Preparation Example 1

An antimicrobial solution was prepared in the same manner as in Preparation Example 1-1, with the exception that the Ag powder was not used (0 g), rather than adding 0.1 g of the Ag powder as in Preparation Example 1-1.

TABLE 1

| | Solvent | Antimicrobial material |
|---|---|---|
| Preparation Example 1-1 | Methanol | 0.1 g of Silver (Ag) |
| Preparation Example 1-2 | (100 ml) | 0.2 g of Silver (Ag) |
| Preparation Example 1-3 | | 0.4 g of Silver (Ag) |
| Preparation Example 1-4 | | 0.8 g of Silver (Ag) |
| Preparation Example 1-5 | | 0.01 g of Silver (Ag) |
| Preparation Example 1-6 | | 0.02 g of Silver (Ag) |
| Preparation Example 1-7 | | 0.04 g of Silver (Ag) |
| Preparation Example 1-8 | | 0.08 g of Silver (Ag) |
| Comparative Preparation Example 1 | | 0 g of Silver (Ag) |
| Preparation Example 2-1 | Ethanol | 0.1 g of Silver (Ag) |
| Preparation Example 2-2 | (100 ml) | 0.2 g of Silver (Ag) |
| Preparation Example 2-3 | | 0.4 g of Silver (Ag) |
| Preparation Example 2-4 | | 0.8 g of Silver (Ag) |

### Example 1: Manufacture of Antimicrobial Adhesive Film

### Example 1-1

Poly(t-butyl acrylate) as an adhesive was applied through blade coating on one surface of a polyethylene substrate film having an area of 380×275 mm², thus manufacturing an adhesive film including an adhesive layer formed thereon. Subsequently, the antimicrobial solution prepared in Preparation Example 1-1 was applied through spray coating on the remaining surface of the adhesive film opposite the surface on which the adhesive layer was for ed, followed by drying, thus manufacturing a laminated film including an antimicrobial material layer/substrate film/adhesive layer. Next, the antimicrobial material layer of the laminated film was located at the outermost position and rolled into a cylinder shape, thus manufacturing an antimicrobial adhesive film. Here, the antimicrobial material layer and the adhesive layer were brought into contact with each other so that the antimicrobial material layer was transferred onto the adhesive layer, ultimately manufacturing an antimicrobial adhesive film having a substrate film/adhesive layer/antimicrobial material layer structure.

### Examples 1-2 to 4-8 and Control Examples 1 to 4

Antimicrobial adhesive films were manufactured in the same manner as in Example 1-1, with the exception that the substrate film, the adhesive, and the antimicrobial solution were changed as shown in Table 2 below.

TABLE 2

| No. | Name | Substrate film | Adhesive | Antimicrobial solution |
|---|---|---|---|---|
| Example 1-1 | A01 | Polyethylene | Poly(t-butyl | Preparation Example 1-1 |
| Example 1-2 | | (PE) | acrylate) | Preparation Example 1-2 |
| Example 1-3 | | | | Preparation Example 1-3 |
| Example 1-4 | | | | Preparation Example 1-4 |
| Example 1-5 | | | | Preparation Example 1-5 |
| Example 1-6 | | | | Preparation Example 1-6 |
| Example 1-7 | | | | Preparation Example 1-7 |
| Example 1-8 | | | | Preparation Example 1-8 |
| Control | | | | Comparative Preparation |
| Example 1 | | | | Example 1 |
| Example 2-1 | A02 | Polyethylene | Poly(ethyl | Preparation Example 1-1 |
| Example 2-2 | | (PE) | acrylate) | Preparation Example 1-2 |
| Example 2-3 | | | | Preparation Example 1-3 |
| Example 2-4 | | | | Preparation Example 1-4 |
| Example 2-5 | | | | Preparation Example 1-5 |
| Example 2-6 | | | | Preparation Example 1-6 |
| Example 2-7 | | | | Preparation Example 1-7 |
| Example 2-8 | | | | Preparation Example 1-8 |
| Control | | | | Comparative Preparation |
| Example 2 | | | | Example 1 |
| Example 3-1 | A03 | Polypropylene | Poly(t-butyl | Preparation Example 1-1 |
| Example 3-2 | | (PP) | acrylate) | Preparation Example 1-2 |
| Example 3-3 | | | | Preparation Example 1-3 |
| Example 3-4 | | | | Preparation Example 1-4 |
| Example 3-5 | | | | Preparation Example 1-5 |
| Example 3-6 | | | | Preparation Example 1-6 |
| Example 3-7 | | | | Preparation Example 1-7 |
| Example 3-8 | | | | Preparation Example 1-8 |
| Example 3-9 | | | | Preparation Example 2-1 |
| Example 3-10 | | | | Preparation Example 2-2 |
| Example 3-11 | | | | Preparation Example 2-3 |
| Example 3-12 | | | | Preparation Example 2-4 |
| Control | | | | Comparative Preparation |
| Example 3 | | | | Example 1 |
| Example 4-1 | A04 | Polyethylene | Scotch brand | Preparation Example 1-1 |
| Example 4-2 | | (PE) | 898 tape | Preparation Example 1-2 |
| Example 4-3 | | | | Preparation Example 1-3 |
| Example 4-4 | | | | Preparation Example 1-4 |
| Example 4-5 | | | | Preparation Example 1-5 |
| Example 4-6 | | | | Preparation Example 1-6 |
| Example 4-7 | | | | Preparation Example 1-7 |
| Example 4-8 | | | | Preparation Example 1-8 |
| Control | | | | Comparative Preparation |
| Example 4 | | | | Example 1 |

*Scotch brand 898 tape: Tape available from 3M

### Test Examples

### Test Example 1: Measurement of Noise Intensity Upon Film Peeling

In order to measure the noise from the antimicrobial adhesive films of Examples 1-1, 2-1, 3-1 and 4-1 when peeled, the antimicrobial adhesive film was unwound on a 3M plate at a predetermined rate for about 5 sec, and the maximum, minimum, and average values of the noise intensity depending on the distance from the sensor position were measured two times, and the results thereof are shown in Table 3 below.

TABLE 3

| | Noise intensity (dB) | | |
|---|---|---|---|
| | Maximum | Minimum | Average |
| Example 1-1 | 67.3 | 82.6 | 76.8 |
| Example 2-1 | 67.0 | 84.2 | 78.4 |
| Example 3-1 | 42.2 | 64.2 | 55.9 |
| Example 4-1 | 46.2 | 82.1 | 66.1 |

As is apparent from Table 3, the average noise intensity values of the antimicrobial adhesive films of Examples 1-1, 2-1, 3-1 and 4-1 when peeled were 76.8 dB, 78.4 dB, 55.9 dB and 66.1 dB, respectively, based on a standard noise intensity (30.5 dB). The antimicrobial adhesive film of Example 3-1 was found to have the lowest noise intensity when peeled.

### Test Example 2: Measurement of Thickness of Antimicrobial Adhesive Film

The results of measurement of the thickness of the antimicrobial adhesive films of Examples 1-1, 2-1, 3-1 and 4-1 are shown in Table 4 below. In order to reduce measurement error, a total of 5 measurements were performed, and the average thickness thereof was determined.

TABLE 4
Thickness of antimicrobial adhesive film (unit: μm)

| Number of | | | | |
|---|---|---|---|---|
| measurements | Example 1-1 | Example 2-1 | Example 3-1 | Example 4-1 |
| 1 | 40 | 40 | 30 | 40 |
| 2 | 50 | 40 | 30 | 40 |
| 3 | 40 | 40 | 30 | 30 |
| 4 | 40 | 40 | 30 | 30 |
| 5 | 50 | 30 | 30 | 30 |
| Average | 44 | 38 | 30 | 34 |

As is apparent from Table 4, it was confirmed that the antimicrobial adhesive films of Examples 1-1, 2-1, 3-1 and 4-1 exhibited a thickness distribution ranging from 30 to 44 μm.

### Test Example 3: Measurement of Odor Intensity

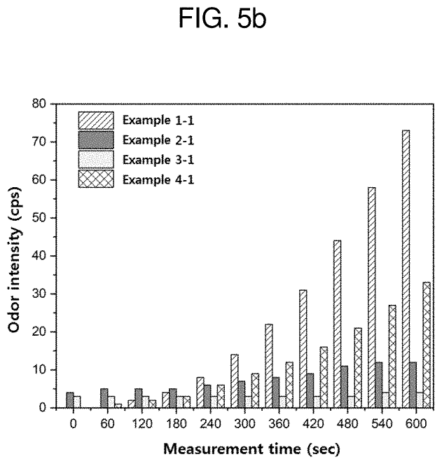

FIGS. 5a and 5b are graphs showing changes in odor intensity depending on the type of film after addition of the NH₄OH aqueous solution in respective amounts of 100 and 200 μl. As an odor source for measurement, 100 or 200 μl of the NH₄OH aqueous solution was diluted with 100 ml of deionized (DI) water and then 3 ml thereof was uniformly applied on a Bemcot washing gauze. The Bemcot washing gauze on which the NH₄OH aqueous solution was applied was placed in a wrapping device, both surfaces thereof were sealed to achieve a size of 45×45 cm², and the odor intensity (odor sensor model: OMX-ADM, Japan) was measured at intervals of 1 min for 10 min.

With reference to FIGS. 5a and 5b, the odor density was increased with an increase in the concentration of the NH₄OH aqueous solution, but it was confirmed that the antimicrobial adhesive films of Examples 1-1, 2-1, 3-1 and 4-1 effectively prevented the odor from escaping.

### Test Example 4: Antimicrobial Activity Test Depending on Amount of Ag

The antimicrobial adhesive film (5 cm×5 cm) was located on a sterilized polypropylene (PP) standard film, after which 0.1 ml of each of Staphylococcus aureus and E. coli culture solutions was applied thereon. Thereafter, the same standard film was compressed thereon, and after 24 hr, the extent of growth of cultured bacteria was measured. The antimicrobial activity was calculated using the following equation. The results thereof are shown in Tables 5 and 6 below.

$$Antimicrobial activity ( \% ) = \frac{\{ \begin{matrix}Number of bacteria after 24 hr ( standard film ) - \\ Number of bacteria after 24 hr ( target film )\end{matrix} \} * 100}{( Number of bacteria after 24 hr ( standard film ) )}$$

TABLE 5
E. coli antimicrobial activity (%)

| Amount of | | | | | |
|---|---|---|---|---|---|
| added Ag | | A01 | A02 | A03 | A04 |
| 0 | g | 0 | 0 | 0 | 0 |
| | | (Control | (Control | (Control | (Control |
| | | Example 1) | Example 2) | Example 3) | Example 4) |
| 0.1 | g | 99.9 | 99.9 | 99.9 | 99.9 |
| | | (Example 1-1) | (Example 2-1) | (Example 3-1) | (Example 4-1) |
| 0.2 | g | 99.9 | 99.9 | 99.9 | 99.9 |
| | | (Example 1-2) | (Example 2-2) | (Example 3-2) | (Example 4-2) |
| 0.4 | g | 99.9 | 99.9 | 99.9 | 99.9 |
| | | (Example 1-3) | (Example 2-3) | (Example 3-3) | (Example 4-3) |
| 0.8 | g | 99.9 | 99.9 | 99.9 | 99.9 |
| | | (Example 1-4) | (Example 2-4) | (Example 3-4) | (Example 4-4) |
| 0.01 | g | 99.9 | 99.9 | 99.9 | 99.9 |
| | | (Example 1-5) | (Example 2-5) | (Example 3-5) | (Example 4-5) |
| 0.02 | g | 99.9 | 99.9 | 99.9 | 99.9 |
| | | (Example 1-6) | (Example 2-6) | (Example 3-6) | (Example 4-6) |
| 0.04 | g | 99.9 | 99.9 | 99.9 | 99.9 |
| | | (Example 1-7) | (Example 2-7) | (Example 3-7) | (Example 4-7) |
| 0.08 | g | 99.9 | 99.9 | 99.9 | 99.9 |
| | | (Example 1-8) | (Example 2-8) | (Example 3-8) | (Example 4-8) |

TABLE 6
Staphylococcus aureus antimicrobial activity (%)

| Amount of | | | | | |
|---|---|---|---|---|---|
| added Ag | | A01 | A02 | A03 | A04 |
| 0 | g | 0 | 0 | 0 | 0 |
| | | (Control | (Control | (Control | (Control |
| | | Example 1) | Example 2) | Example 3) | Example 4) |
| 0.1 | g | 99.9 | 99.9 | 99.7 | 95.4 |
| | | (Example 1-1) | (Example 2-1) | (Example 3-1) | (Example 4-1) |
| 0.2 | g | 99.9 | 99.9 | 99.9 | 99.9 |
| | | (Example 1-2) | (Example 2-2) | (Example 3-2) | (Example 4-2) |
| 0.4 | g | 99.9 | 99.9 | 99.9 | 99.9 |
| | | (Example 1-3) | (Example 2-3) | (Example 3-3) | (Example 4-3) |
| 0.8 | g | 99.9 | 99.9 | 99.9 | 99.9 |
| | | (Example 1-4) | (Example 2-4) | (Example 3-4) | (Example 4-4) |
| 0.01 | g | 99.9 | 99.9 | 99.9 | 72.6 |
| | | (Example 1-5) | (Example 2-5) | (Example 3-5) | (Example 4-5) |
| 0.02 | g | 99.9 | 99.9 | 99.9 | 99.9 |
| | | (Example 1-6) | (Example 2-6) | (Example 3-6) | (Example 4-6) |
| 0.04 | g | 99.9 | 99.9 | 99.9 | 93.7 |
| | | (Example 1-7) | (Example 2-7) | (Example 3-7) | (Example 4-7) |
| 0.08 | g | 99.9 | 99.9 | 99.9 | 99.6 |
| | | (Example 1-8) | (Example 2-8) | (Example 3-8) | (Example 4-8) |

As is apparent from Tables 5 and 6, an increase in antimicrobial activity means that the growth of target bacteria is inhibited, and thus the antimicrobial activity against E. coli was 99.9% or more in all of the antimicrobial adhesive films, and the antimicrobial activity against Staphylococcus aureus was 99.9% in all of the films except for the antimicrobial adhesive film of A04.

Therefore, it was confirmed that the antimicrobial adhesive film according to the present invention exhibited excellent antimicrobial activity.

### Test Example 5: SEM Surface Image and EDS Composition Analysis of Antimicrobial Adhesive Film

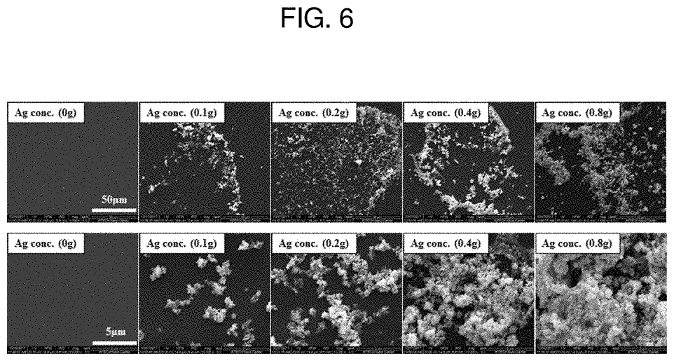

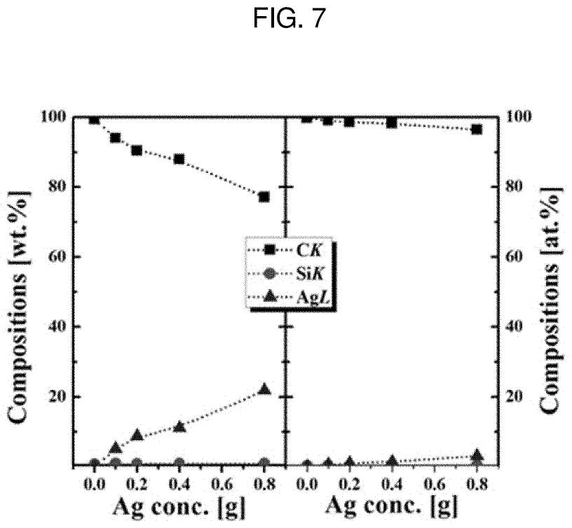

FIG. 6 shows the SEM surface images depending on the amount of Ag in the antimicrobial adhesive films of Examples 3-1 to 3-4 and Control Example 3-1 (top: ×1k, bottom: ×10k), and FIG. 7 is a graph showing the results of analysis of EDS composition for the SEM images of FIG. 6.

With reference to FIG. 6, the density of Ag component per unit area was increased with an increase in the amount of Ag. As shown in the SEM low-magnification images (top), Ag particles were generally uniformly distributed.

With reference to FIG. 7, FIG. 7 shows the results of measurement of the amount of Ag on the antimicrobial film surface, which is represented as weight percent (left) and represented as atomic percent (right). When the amount of Ag that was added to 100 ml of ethanol was increased to 0, 0.1, 0.2, 0.4, and 0.8 g and thus the concentration of the Ag antimicrobial solution was raised, the amount of Ag particles remaining on the surface of the antimicrobial film after spray coating was increased, from which the amount of Ag present on the surface of the Ag antimicrobial film was quantitatively confirmed.

### Test Example 6: AFM Surface Analysis of Antimicrobial Adhesive Film

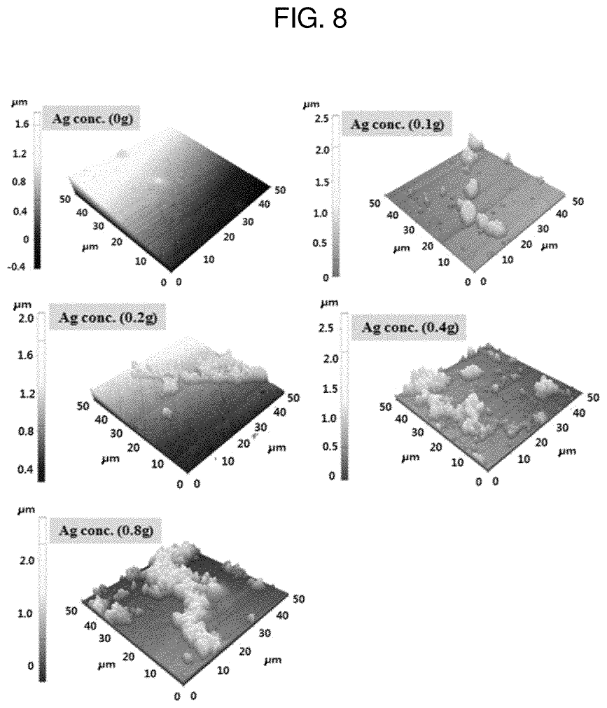

FIG. 8 shows the AFM surface analysis images of the antimicrobial adhesive films of Examples 3-1 to 3-4 and Control Example 3-1.

With reference to FIG. 8, the distribution of Ag particles in the scan area (50 μm×50 μm) was confirmed through AFM. The roughness of the antimicrobial adhesive film according to the present invention was about 2 to 2.5 μm regardless of the amount of Ag. However, the agglomeration of particles was increased with an increase in the amount of Ag. The agglomeration of the particles is deemed to be capable of acting as a factor that reduces the antimicrobial properties of nano-sized Ag particles.

### Test Example 7: Surface Analysis Depending on Concentration of Antimicrobial Solution

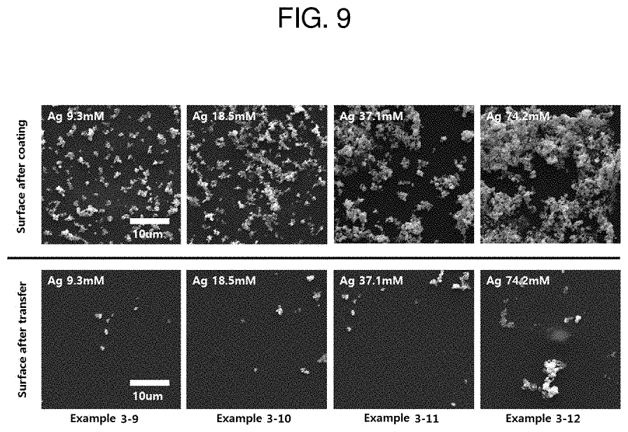

FIG. 9 shows SEM surface images of the antimicrobial adhesive films of Examples 3-9 to 3-12. The number of moles (mol) and the molar concentration (M) of Ag depending on the amount of Ag that was added are shown in Table 7 below.

TABLE 7
Concentration of Ag antimicrobial solution (@ 100 ml of ethanol)

| Antimicrobial | Preparation | Preparation | Preparation | Preparation |
|---|---|---|---|---|
| solution | Example 2-1 | Example 2-2 | Example 2-3 | Example 2-4 |
| Amount of added Ag | 0.1 | 0.2 | 0.4 | 0.8 |
| Number of moles | 0.00093 | 0.00185 | 0.00371 | 0.00742 |
| (mol) of Ag | | | | |
| Molar concentration (M) | 9.3 | 18.5 | 37.1 | 74.2 |
| of Ag | | | | |

With reference to FIG. 9 and Table 7, when the molar concentration of the Ag antimicrobial solution was increased, the amount of Ag present on the surface of the antimicrobial film was increased. As shown in the images of FIG. 9 of the surface after coating of the film with the Ag antimicrobial material (top) and the surface after transfer of the antimicrobial material onto the adhesive layer (bottom), the antimicrobial material was transferred onto the adhesive layer by the method of manufacturing the antimicrobial adhesive film according to the present invention, indicating that almost all of the Ag antimicrobial material applied on the surface of the film was moved to the adhesive layer after the transfer process.

As described hereinbefore, preferred embodiments of the present invention have been disclosed for illustrative purposes but the present invention is not limited thereto, and those skilled in the art will appreciate that various modifications are possible within the scope of the technical idea of the present invention.

### INDUSTRIAL APPLICABILITY

The present invention provides a method of manufacturing an antimicrobial adhesive film, in which the film is rolled into a cylinder shape to thereby transfer the antimicrobial material onto the adhesive layer, so there is no limitation on use of solvents due to no reactivity between the adhesive and the antimicrobial solution, and the manufacturing process is easy.

In addition, the present invention provides a method of manufacturing an antimicrobial adhesive film, which is capable of completely sealing medical waste to prevent odors from escaping therefrom and minimizing noise when the film is peeled and manifests excellent antimicrobial activity.

1. A method of manufacturing an antimicrobial adhesive film, comprising:
(a) providing an adhesive film comprising a substrate film and an adhesive layer formed on one surface of the substrate film;
(b) forming a laminated film comprising an antimicrobial material layer/substrate film/adhesive layer by applying an antimicrobial solution comprising an antimicrobial material and a solvent on a remaining surface of the substrate film of the adhesive film and performing drying; and
(c) manufacturing an antimicrobial adhesive film comprising a substrate film/adhesive layer/antimicrobial material layer by rolling the laminated film into a cylinder shape so that the antimicrobial material layer and the adhesive layer are brought into contact with each other to thereby transfer the antimicrobial material layer onto the adhesive layer.

2. The method of claim 1, wherein the rolling the laminated film into a cylinder shape in step (c) is performed in a manner in which the antimicrobial material layer is located at an outermost position of the cylinder shape and rolled or in a manner in which the adhesive layer is located at an outermost position of the cylinder shape and rolled.

3. The method of claim 2, wherein the rolling the laminated film into a cylinder shape in step (c) is performed in a manner in which the antimicrobial material layer is located at the outermost position of the cylinder shape and rolled.

4. The method of claim 1, further comprising (b′) controlling a concentration of the antimicrobial material in the antimicrobial solution so that the antimicrobial material is uniformly distributed on the remaining surface of the substrate film of the adhesive film and is formed on a portion of the remaining surface of the substrate film, before step (b).

5. The method of claim 1, wherein the applying the antimicrobial solution in step (b) is performed through any one process selected from the group consisting of spray coating, blade coating and gravure coating.

6. The method of claim 1, wherein the antimicrobial material of step (b) comprises metal nanoparticles comprising at least one selected from the group consisting of Ag, Cu, Pt, Au, Zn and Pd.

7. The method of claim 1, wherein the antimicrobial material of step (b) comprises oxide nanoparticles comprising at least one selected from the group consisting of TiO₂, ZnO, CaO and SiO₂.

8. The method of claim 1, wherein the antimicrobial material of step (b) is an antimicrobial organic material comprising phytoncide.

9. The method of claim 1, wherein the solvent of step (b) comprises at least one selected from the group consisting of sodium citrate, ionic liquid, ethanol, methanol, n-propyl alcohol, isopropyl alcohol and water.

10. The method of claim 1, wherein the substrate film of step (a) comprises at least one selected from the group consisting of polyethylene (PE), polypropylene (PP), polyimide (PI), polyethylene terephthalate (PET), polycarbonate and polyethylene naphthalate.

11. The method of claim 1, wherein the substrate film of step (a) has a thickness of 10 to 100 μm.

12. The method of claim 1, wherein the adhesive layer of step (a) comprises at least one selected from the group consisting of rubber, acrylic polymer, adipate-based polymer, silicone-based polymer and urethane-based polymer.

13. The method of claim 1, wherein the adhesive layer of step (a) has a thickness of 0.1 to 10 μm.

14. The method of claim 1, wherein step (a) comprises:
(a-1) providing a substrate film; and
(a-2) forming an adhesive layer comprising an adhesive on one surface of the substrate film.

15. A method of manufacturing an antimicrobial adhesive film, comprising:
(1) manufacturing an antimicrobial material layer/substrate film by applying an antimicrobial solution comprising an antimicrobial material and a solvent on one surface of a substrate film and performing drying;
(2) manufacturing a laminated film comprising an antimicrobial material layer/substrate film/adhesive layer by forming an adhesive layer on a remaining surface of the substrate film of the antimicrobial material layer/substrate film; and
(3) manufacturing an antimicrobial adhesive film comprising a substrate film/adhesive layer/antimicrobial material layer by rolling the laminated film into a cylinder shape so that the antimicrobial material layer and the adhesive layer are brought into contact with each other to thereby transfer the antimicrobial material layer onto the adhesive layer.

16. The method of claim 15, wherein the rolling the laminated film into a cylinder shape in step (3) is performed in a manner in which the antimicrobial material layer is located at an outermost position of the cylinder shape and rolled or in a manner in which the adhesive layer is located at an outermost position of the cylinder shape and rolled.

17. The method of claim 16, wherein the rolling the laminated film into a cylinder shape in step (3) is performed in a manner in which the antimicrobial material layer is located at the outermost position of the cylinder shape and rolled.

18. The method of claim 15, wherein in step (1), a concentration of the antimicrobial material in the antimicrobial solution is controlled so that the antimicrobial material is uniformly distributed on the one surface of the substrate film and is formed on a portion of the one surface of the substrate film.

19. A method of sealing waste, comprising:
providing an antimicrobial adhesive film produced by the method of claim 1;
locating waste on a portion of an adhesive layer of the antimicrobial adhesive film; and
sealing the waste by folding the adhesive layer of the antimicrobial adhesive film so as to come into contact with the same and adhering a remaining portion of the adhesive layer.
